(19) United States
(12) Patent Application Publication
(10) Pub. No.: US 2021/0387906 A1
(43) Pub. Date: Dec. 16, 2021

(54) METHOD AND FACILITY FOR MARKING HOT GLASS CONTAINERS

(71) Applicant: TIAMA, VOURLES (FR)

(72) Inventors: Michel OLLIVIER, ACIGNE (FR); Anthony GUTRIN, LYON (FR); Dominique PITAVAL, SAINT-CHRISTO-EN-JAREZ (FR); Pierre-Yves SOLANE, LYON (FR)

(21) Appl. No.: 17/287,153

(22) PCT Filed: Oct. 21, 2019
(86) PCT No.: PCT/FR2019/052498

§ 371 Date: Apr. 21, 2021

(30) Foreign Application Priority Data
Oct. 22, 2018 (FR) 1859712

(51) Int. Cl. C03C 23/00; B41M 5/26; B41M 5/24; B23K 26/00; B23K 26/03; B23K 26/046; B23K 26/042; B23K 26/0622; B23K 26/08; B23K 26/082; B23K 26/354

(52) U.S. Cl. CPC C03C 23/0025; B41M 5/262; B41M 5/24; B23K 26/0006; B23K 26/034; B23K 26/046; B23K 2101/04; B23K 26/0622; B23K 26/0838; B23K 26/0869; B23K 26/082; B23K 26/354; B23K 26/042

(57) ABSTRACT

A method for marking, at the outlet of a forming machine using a laser beam, a marking area on hot glass containers comprises determining the longitudinal and transverse positions of the marking area of each container by positioning a first optical axis of a first light sensor and a second optical axis of a second light sensor in a non-parallel manner to each other, in a detection plane parallel to the conveying plane of the containers, detecting the instant of intersection or disengagement, by a container, of the first optical axis and the instant of intersection or disengagement, by a container, of the second optical axis, and calculating said transverse and longitudinal positions from these instants and in consideration of a known or constant speed of translation of the containers. The method can determine the marking instant for each container running past the laser apparatus.

The present invention relates to the technical field of hot-marking, at high rate, glass containers such as bottles or flasks coming out of a manufacturing or forming machine.

In the field of the manufacture of glass containers, it is known to use marking systems either at the outlet of the forming machine or in the cold part of the manufacturing process, in order to make a timestamping with a view to ensuring the manufacturing traceability.

Conventionally, a forming machine consists of different independent juxtaposed sections, each comprising at least one cavity, the cavities each being equipped with a mold in which the container takes its final shape at high temperature. At the end of forming in a section, the containers are extracted from the cavities of the section and deposited on holding plates at the edge of an output conveyor. Then mechanisms for placing containers in line, called shifting hands, move the containers by sliding them on the output conveyor of the forming machine. The order in which the containers from different sections are arranged on the output conveyor of the forming machine is constant for a given production, but varies between the productions and along the manufacturing lines. In other words, for example for a machine of 10 sections and 2 cavities per section, called 10 double gob, the order of running of the sections is not 1 . . . 2 . . . 3 . . . 4 but it can be known in advance. At the outlet of the forming machine, the containers are routed so as to constitute a queue on a transport conveyor causing the containers to run successively past various processing stations such as spraying and annealing.

It appears advantageous to mark the containers as soon as possible at the outlet of the forming machine so as not to create a time lag in the detection of defects likely to occur as a result of accumulation of the containers or errors in the traceability.

In the state of the art, various solutions have been proposed to mark, in a marking area, objects at high temperature coming out of a forming machine. For example, patent U.S. Pat. No. 4,870,922 describes an apparatus for marking by controlled spraying of a fluid. The marking head is disposed along the conveyor routing the objects at the outlet of the forming machine. In practice, it turns out that the fluid deposited on the surface in the form of a code or a marking is altered or even erased, during the operations of handling, filling or washing the glass articles, inherent in the glassmaking process.

To address the problems of keeping the code or the marking in time, it is known in particular from document JP 09 128 578 to use a laser marking system which makes markings or codes on the surface of the articles, by ablation or melting of the glass. The advantage of this technology lies in the fact that the code is indelible and withstands very well the handling, filling or washing operations inherent in the glassmaking process.

This laser marking technique is also known to be implemented in the cold part of the process for manufacturing the glass objects. For example, document EP 0 495 647 describes a facility adapted to calculate the speed of running of the objects so as to ensure a corresponding marking on the objects. Likewise, documents WO 2004/000749 and US 2003/052100 provide for detecting the position of the objects along its direction of displacement before ensuring an operation of marking the object. Furthermore, patent EP 2 719 643 describes a method for aligning glass containers using a thermal imaging camera.

However, these laser marking techniques have the drawback of not being able to safely and effectively ensure the ablation or melting of the glass. Indeed, it has been observed that the laser does not provide enough power to the marking location to make the melting of the glass, since the objects are not always in the plane of focus of the laser.

It turns out indeed that the containers are never perfectly aligned at the outlet of the forming machine. The use of guides or mechanisms for aligning the hot containers running at the outlet of the forming machine is able to generate defects by contact with the guides or by creating contacts between the containers by slowing them down on the conveyor. When these glass containers are at high temperature, these contacts generate defects since the glass at high temperature is still deformable.

According to patent EP 2 368 861, the transverse position of the containers is determined before the marking made at the outlet of the forming machine. The position is measured with an infrared linear camera observing the running containers from above. If this solution allows the optimization of the marking by the measurement of the transverse position of the containers, it has been observed that the environment filled with vapors and dust in which the camera is positioned is able to affect its performances. Furthermore, it should be noted that this camera overhanging the containers, generally visualizes the widest part of the object so that this solution is not able to accurately determine the position of the neck of the containers so that the neck marking cannot be carried out correctly. Indeed, the system gives the position of the container on the conveyor. If a container has a leaning neck defect, the position of the neck derived from the position of the body is wrong.

The object of the invention therefore aims at overcoming the drawbacks of the prior art by proposing a simple and inexpensive method adapted to ensure, at the outlet of a forming machine, effective laser marking of hot containers without risking to damage the objects during their conveyance to the marking station.

To achieve such an objective, the object of the invention relates to a method for marking, at the outlet of a forming machine using a laser beam, a marking area on hot glass containers laid on a conveying plane of a conveyor and running in translation successively past a laser apparatus, the method including the following steps:
determining for each container before its marking, the longitudinal position along the translation direction and the transverse position along a transverse direction relative to the direction of translation of the marking area;
moving, along the transverse direction, the plane of focus of the laser beam as a function of the transverse position of the marking area of each container to optimize the subsequent operation of marking the containers running past the laser beam;
and making on the marking area of each container, a marking along a marking axis by the laser beam whose position of the focus plane has been optimized to ensure the marking;

According to the invention, the method, in order to determine the longitudinal position and the transverse position of the marking area of each container, consists in:
positioning a first optical axis of a first light sensor and a second optical axis of a second light sensor in a non-parallel manner to each other, in a detection plane parallel to the conveying plane and located at a height at least close to the height of the marking area, the first optical axis and the second optical axis being located so that each container is caused to cross each optical axis during its translation before the marking, the direction of the optical axes relative to the direction of displacement and their position relative to the marking axis being known;
detecting the instant of intersection or disengagement, by a container, of the first optical axis and the instant of intersection or disengagement, by a container, of the second optical axis;
and calculating said transverse and longitudinal positions from these instants and in consideration of a known or constant speed of translation of the containers;
the method consisting in determining, from the determination of the longitudinal position of the marking area, the marking instant for each container running past the laser apparatus.

According to one variant, for which for example, the diameter of the container is not known or the section of the container is not circular, the method consists in:
detecting the instant of intersection of the first optical axis by a hot container, and
detecting the instant of disengagement of the first optical axis by a hot container, and
detecting the instant of intersection of the first optical axis by a hot container, and
detecting the instant of disengagement of the first optical axis by a hot container;
   to derive therefrom the transverse and longitudinal position of the center of central symmetry of the section by the detection plane, of the casing of each container, and to derive the longitudinal position of the marking area from at least the longitudinal position of the center of symmetry, and to derive the transverse position of the marking area from at least the transverse position of the center of symmetry.

According to one advantageous characteristic of embodiment, the optical axes of the light sensors are positioned so that the detection plane is secant to the marking area and preferably in the middle of the marking area.

The variation in the transverse position of the containers is able to lead to a variation, from one container to another, in the vertical and horizontal dimensions of the marking. In the case of a marking such as a DATAMATRIX code, intended for automatic reading, such a variation in the dimensions of the code presents a risk of incorrect reading.

Another object of the invention aims at overcoming the drawbacks of the prior art by proposing a suitable method for ensuring, whatever the transverse position of the container, a marking having dimensions corresponding to those desired.

To achieve such an objective, the object of the invention relates to a method according to which the measurement of the transverse position of the marking area is taken into account in order to control the laser apparatus by adapting at least the horizontal displacements of the laser beam as a function of the speed of displacement and of the transverse position of the marking area of each container in order to maintain constant at least the width of the marking area.

It turns out that the containers are oriented on the output conveyor, with different angulations relative to the direction of displacement. For circular containers, this positioning only poses a problem if the marking area must be made in an accurate position on the container. The case of non-circular containers presenting for example a planar face in the center of which the marking must be made, as a result the face of the container is not normal to the laser beam. As a result, the geometry of the marking is modified. In the case of marking such as a DATAMATRIX code intended for automatic reading, such deformation of the code presents a risk of incorrect reading.

One object of the invention aims at overcoming the drawbacks of the prior art by proposing a method adapted to ensure, whatever the orientation of the containers relative to the translation direction, a quality marking corresponding to the desired one.

To achieve such an objective, the object of the invention relates to a method in which, from the four instants of intersection and disengagement of the first sensor and second sensor, the orientation of the section of the container is determined by the detection plane of the casing of each container, and as a function of said orientation:
the transverse position and the longitudinal position of the marking region are determined;
and/or the scanning device is driven to obtain a marking with a geometry compliant with the desired one;
and/or alert information is delivered when the orientation exceeds a marking quality value.

The techniques of laser marking of the containers are based on the ablation or melting of the glass. It has been observed sometimes that the marking made does not have a good quality, that is to say the relief of the marking is insufficient to allow optical reading and/or defects are created at the impacts of the laser beam. Furthermore, it is important that the geometry of the marking and its position on the containers are those expected, for aesthetic reasons and above all for facilitating automatic reading in the case of bar or matrix codes.

One object of the invention aims at overcoming the drawbacks of the prior art by proposing a method adapted to ensure, at the outlet of a forming machine, a marking having good quality.

To achieve such an objective, the object of the invention relates to a method in which an optical monitoring pyrometer is disposed to provide, from the infrared radiation emitted by the hot containers, a measurement of the temperature of the marking area the moment when said area intersects its optical axis, in order to determine whether said temperature is above a temperature threshold such that the engraving is of good quality.

In the case that the measurement of temperature of the marking region is below a determined threshold, at least one of the following actions is carried out:
positioning of an alarm signal, possibly resumed by a visual or audible alert or the like, intended for the operators of the line;
the non-marking of the container whose temperature measurement is insufficient;
the operating of a device for heating the marking area, located upstream of the laser apparatus;
a modification of the container forming method, aiming at raising the temperature of the marking area.

The height at which the marking area is positioned depends on the needs of the production and shape of the containers. Depending on the operating conditions, on the ambient atmosphere, but also on the more or less hot glass containers, expansion phenomena cause deformations of the output conveyor, so that particularly, the height of the output conveyor changes at the location of the marking station. These spontaneous and involuntary changes in the height of the conveyor, with an amplitude that can reach+/−1 cm and referred to as height drift, can therefore modify the marking height.

One object of the invention aims at overcoming the drawbacks of the prior art by proposing a method adapted to ensure, at the outlet of a forming machine, a marking having a correct positioning of the marking area on the container and relative to the container.

To achieve such an objective, the object of the invention relates to a method according to which the height of the conveying plane is measured at least regularly, and in that the control unit drives, as a function of the measurement of the height of the conveying plane, means for height-adjusting the position of the laser apparatus in order to maintain the marking area or the marking axis at a fixed height relative to the conveying plane.

According to one variant, the height of the conveying plane is measured at least regularly, and the control unit drives, as a function of the measurement of the height of the conveying plane, the laser beam scanning system to maintain the marking area at a fixed height relative to the conveying plane.

Depending on the production, the output conveyor can have a variable slope, therefore an inclination relative to the ground. If the conveyor is not horizontal, then the axis of the containers is not vertical, and especially the conveying plane is not horizontal. However, if the scanning of the laser beam is not adapted, the marking may present a diamond-shaped deformation, and ultimately no longer correspond to the desired shape.

One object of the invention aims at overcoming the drawbacks of the prior art by proposing a method adapted to ensure, at the outlet of a forming machine, a marking having a correct geometry of the marking area on the container and relative to the container.

To achieve such an objective, the object of the invention relates to a method according to which the inclination of the conveying plane is taken into account and the laser beam scanning system is driven in order to maintain the geometry of the marking.

Another object of the invention is to propose a facility for marking, at the outlet of a forming machine, hot glass containers laid on a conveying plane of a conveyor and running successively, at a constant or known speed of translation, past a laser apparatus, the facility including:
a system for determining, before their marking, the longitudinal position of the marking region along the direction of translation of the containers and the transverse position of the marking region in a direction transverse to the direction of running of the containers;
a laser apparatus including a laser beam generator along a marking axis;
and a control unit configured to drive a device for moving, along the transverse direction, the plane of focus of the laser beam as a function of the transverse position of the marking region in order to optimize the operation of marking the containers running past the laser beam. According to the invention, the system for determining the longitudinal position and the transverse position of the marking area of each container includes:
a first light sensor having a first optical axis and a second light sensor having a second optical axis, these optical axes being positioned in a non-parallel manner to each other, in a detection plane parallel to the conveying plane and located at a height at least close to the height of the marking area, the first optical axis and the second optical axis being located so that each container is caused to cross each optical axis during its translation, the direction of the optical axes relative to the direction of displacement and their position relative to the marking axis being known;
and a processing unit detecting the instant of intersection or disengagement, by a container, of the first optical axis and the instant of intersection or disengagement, by a container, of the second optical axis, and calculating said transverse and longitudinal positions from these instants and in consideration of a known or constant speed of translation of the containers, this processing unit determining the marking instant for each container running past the marking station, from the determination of the longitudinal position of the marking area.

Various other characteristics emerge from the description given below with reference to the appended drawings which show, by way of non-limiting examples, embodiments of the object of the invention.

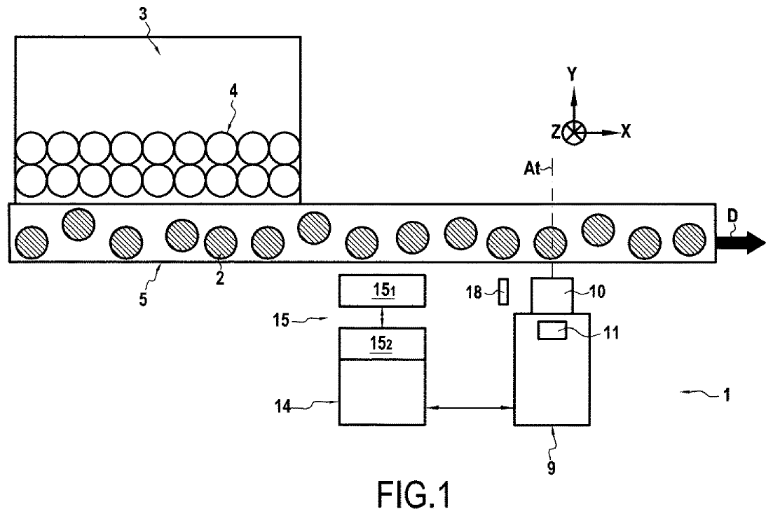

FIG. 1 is a schematic view illustrating one exemplary embodiment of a marking facility according to the invention.

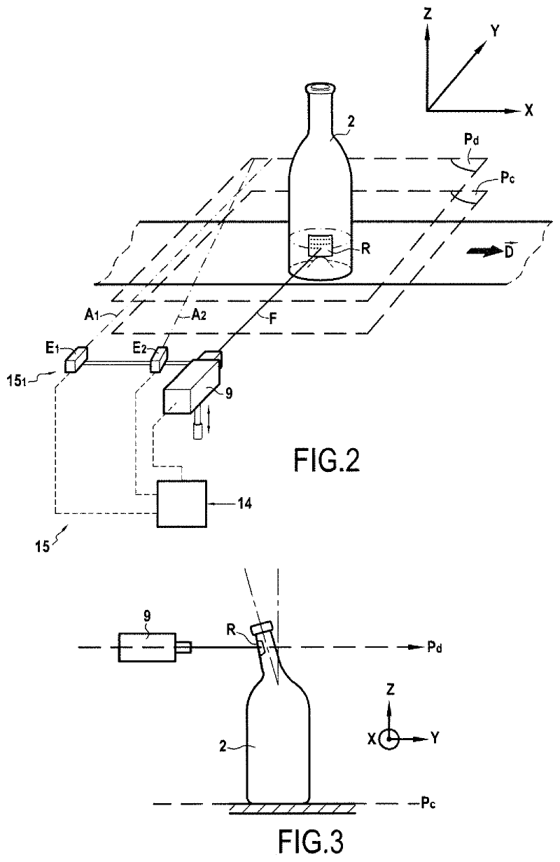

FIGS. 2 and 3 are perspective and side views respectively, showing characteristics of the facility according to the invention.

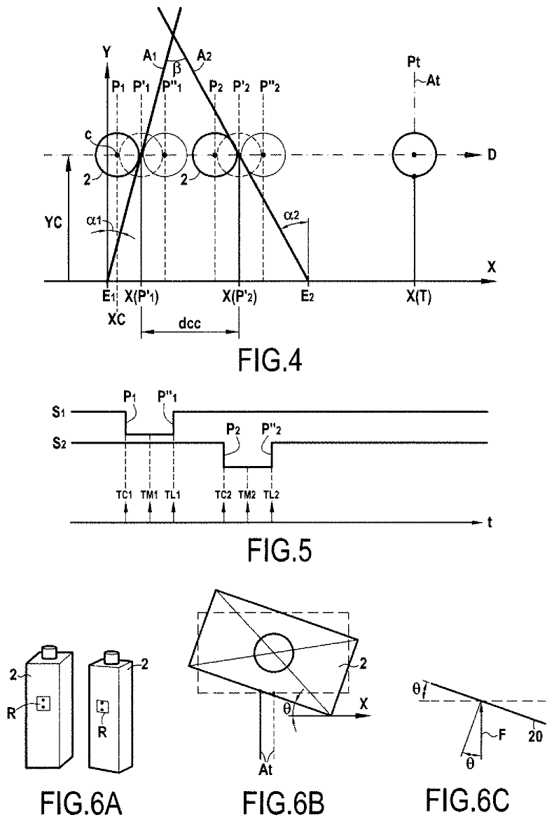

FIG. 4 is a simplified diagram showing the different positions of a container of circular section in the detection plane relative to light sensors allowing illustrating the calculations to determine the transverse position and the longitudinal position of the container relative to the laser apparatus.

FIG. 5 is a diagram showing the output signals of the light sensors and instants of intersection and disengagement of the container relative to the light sensors, for the different positions of the container illustrated in FIG. 4.

FIGS. 6A and 6B are perspective and top views respectively, showing rectangular-shaped containers having two orientations about the vertical axis different from the translation direction.

FIG. 6C is a detail view showing the axis of firing of the laser beam on the face of the container.

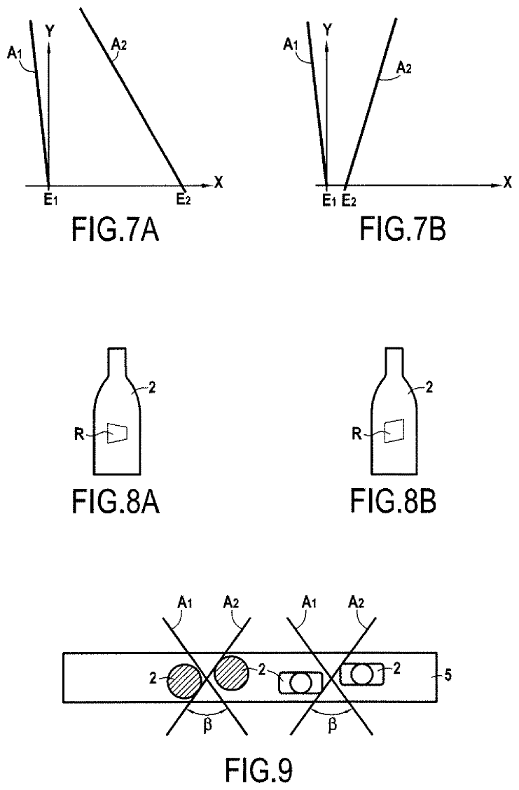

FIGS. 7A and 7B illustrate examples of orientation of the optical axes for light sensors.

FIG. 8A is a view showing the deformation of the trapezoidal-shaped marking when the container has a non-zero orientation about the vertical axis.

FIG. 8B is a view showing the deformation of the diamond-shaped marking when the conveying plane is inclined.

FIG. 9 is a view showing the first and second optical axes for the first and second light sensors and an angle relationship therebetween.

The object of the invention relates to a facility 1 for marking or hot-engraving glass containers 2 such as, for example, glass bottles or flasks.

The facility 1 is placed so as to ensure the marking of the containers 2 coming out of a manufacturing or forming machine 3 and thus each having a high temperature. The forming machine 3 conventionally includes a series of cavities 4 each ensuring the forming of a container 2. In a known manner, the containers 2 which have just been formed by the machine 3 are laid on a conveying plane Pc of an output conveyor 5 defined by axes X, Y. The containers 2 thus constitute a queue on the conveyor 5. The containers 2 are thus routed one after the other to different processing stations along a translation or running direction D parallel to the direction X. Conventionally, the conveying plane Pc is generally horizontal.

It should be noted that the containers deposited successively on the output conveyor 5 are not aligned very accurately along the direction X. Insofar as the containers 2 are hot, the facility does not include a mechanical system allowing aligning through contact the containers to avoid by contact the creation of various defects such as stress, glazes or deformations, frictions, etc. The containers 2 thus have random positions along the transverse direction Y.

The marking facility 1 is placed in relation to the output conveyor 5 of the forming machine 3 to ensure the marking of the containers while they are still hot. The marking facility 1 is thus placed at the outlet of the forming machine 3 on the path of the output conveyor 5 which thus ensures the successive running, past the facility along the running direction D, of the containers 2 at high temperature.

The marking facility 1 includes an apparatus 9 for producing a laser beam F of all types known per se. In the following description, the laser apparatus 9 has a marking axis At which corresponds to the optical axis of the front or output lens. The marking axis At is generally directed along the direction Y transverse to the displacement. The laser apparatus 9 according to the invention conventionally includes a scanning device 10 or scanner, upstream of the output lens, protected by the output window of the laser beam. This output lens called F-theta lens shapes the laser beam to concentrate power at the marking location. The scanning device 10 allows, by its driving, angularly moving the direction of the laser beam, through the output lens and about the marking axis At. Thus the marking axis At is for example the optical axis of the F-theta lens, it is generally directed along the direction Y transverse to the displacement. The laser apparatus 9 according to the invention also includes a device 11 for moving the plane of focus of the laser beam F from front to back along the direction of the marking axis At, namely the transverse direction Y. In other words, the laser apparatus 9 includes means for making optical corrections so as to move the position of the working plane of the laser transversely relative to the direction D of running of the objects, that is to say in the example illustrated, perpendicular to the plane defined by the axes X, Z. For example, the laser apparatus 9 includes as displacement device 11, a motorized optical system driven in displacement.

In the illustrated example, the laser beam F has a direction substantially perpendicular to the conveying direction D, that is to say perpendicular to the plane defined by the axes X, Z. Of course, it can be envisaged that the scanning device 10 orients the laser beam F along a transverse direction different from a perpendicular direction such as inclined relative to the conveying direction D. In any case, the device 11 ensures the displacement of the plane of focus of the laser beam F, along a transverse direction Y relative to the conveying direction D, that is to say along a direction Y which intersects this conveying direction D.

The laser apparatus 9 makes on each container, a marking in a marking area or region R of the container 2. The marking area or region R refers to a region or a portion of the wall of each container, generally the same on each container, that will receive the marking. The marking area R is positioned at an accurate height of the container chosen according to various criteria and for example taken relative to the bottom of the container. As illustrated in FIGS. 2 and 3, the marking area R is located on the body or the neck of a container. The marking is generally made on the outer surface of the containers, therefore the marking area is a portion of the surface of the wall. But the invention can be applied when the marking is made within the thickness of the wall of the hollow glass containers.

Each marking can be made alphanumerically or by symbolic coding such as a bar code or a DATAMATRIX code. The information can be encrypted or unencrypted. The marking may include several elements such as for example a DATAMATRIX code and alphanumeric information.

The marking thus includes patterns corresponding to the impacts of the laser beam on the container. In the case of a DATAMATRIX code, the patterns are hollows each corresponding to an impact of the pulsed laser, each hollow constituting a dot of the dot code. In the case of an alphanumeric code, the patterns are letters or numbers.

In the case of a DATAMATRIX code, the marking region R is reduced to a square. In the case that the marking is a text, the marking region R is defined for example horizontally, by the length of the text and vertically, by the height of the characters. If the marking is composed of 2 different graphic elements offset from each other, the marking area is the region that can contain them.

Advantageously, the laser apparatus 9 is synchronized with the forming machine 3, so as to make on each container, a marking giving at least one information dependent on the original forming cavity. Thus, it may be provided to mark, for example, the number of the original forming mold or cavity. The synchronization consists for example in recording, in the memory of the laser apparatus, the order in which the sections come out of the forming machine 3, therefore the order of running of the containers in the marking station, according to their original cavity.

It should be noted that the marking facility 1 can make, on each container 2, a marking giving information, for example on the forming machine, the manufacturing line and/or the manufacturing plant and/or the marking instant, preferably constituting a unique identification for each of the containers.

The marking facility 1 includes a control unit 14 or controller, configured to drive the operation of the laser apparatus 9. The marking facility 1 also includes a system 15 for determining the position of each container 2 along the direction Y transverse to the direction of translation D of the containers and the longitudinal position X of the marking region R along the direction of translation D of the containers. This determination system 15 includes a system of sensors 15₁ placed upstream of the laser apparatus 9 in consideration of the running direction D. This sensor system 15₁, which detects the passage of each container, is connected to a processing unit 15₂ configured to determine the transverse and longitudinal positions of the marking region R.

This determination system 15 transmits to the control unit 14 the position of the marking region R of each container 2 along the transverse direction Y allowing driving the device 11 for moving the laser apparatus 9. This control unit 14 thus allows adapting, as a function of the transverse position of the containers to be marked, the plane of focus of the laser beam F such that the latter can ensure, when the containers pass past the apparatus 9, suitable marking of the containers.

This determination system 15 also transmits, to the control unit 14, the position of each container 2 along the longitudinal direction X allowing driving the laser apparatus 9 in order to ensure the marking in the marking area R. From the determination of the longitudinal position of the marking area, the control unit 14 determines the marking instant for each container such that the laser apparatus 9 ensures the marking when each container runs past the laser apparatus. Of course, the control unit 14 determines the marking instant from the knowledge of the speed of translation Vt of the conveyor and the position of the marking axis At along the longitudinal direction relative to the position of the container.

More specifically, the marking operation has a certain duration, during which the direction of the laser beam F is angularly moved from top to bottom and from left to right about the marking axis At so that the impact of the laser beam travels through the marking area R as a function in particular of the patterns to be marked and of the speed of the conveyor. Therefore, the marking instant is actually, for example and for the sake of simplification, the instant of the beginning of the marking operation.

When the speed of the conveyor is constant, it suffices for the control unit 14 to have the value of the speed in memory. Otherwise, the speed of the conveyor can be known at any time in different ways.

A device for measuring the speed of displacement of the conveyor connected to the control unit 14 can be provided. According to a first solution, the control unit receives the signal “top machine IS” from the forming machine. This top of the forming machine, hereinafter top machine, is a signal triggered at each complete cycle of the forming machine, that is to say for example each time the set of the molds has been emptied once. If the manufacturing rate increases or decreases, the frequency of the top machine changes proportionally, as well as the speed of the conveyor. The top machine of the forming machine provides information on the rate and therefore on the conveying speed. Alternatively, the control unit 14 triggers the marking from a count of a given number of pulses delivered by an encoder informing on the actual advance of the conveyor, which is equivalent to knowing the speed Vt and a time.

According to a third possibility, it can be provided to use two optical sensors with parallel axes, separated by a known distance. According to this possibility, it is possible to use a third optical axis parallel to and associated with the first or second optical axis. It suffices to take into account the time that elapses between two events of intersection or release of the two optical axes of these sensors to deduce therefrom the speed of the containers and that of the conveyor. In the absence of sliding, the speed of the containers is also the speed of the output conveyor.

The control unit 14 is made by means of any computer systems and can advantageously integrate the processing unit 15₂ of the determination system 15. For example, this control unit 14 is configured to determine or store the speed of the conveyor, to determine the transverse and longitudinal positions of the marking region R, the focus distance, the firing instant, the content of the information to be engraved, to control the laser apparatus, the scanning device 10 and the device 11 for moving the focus plane. This control unit 14 is synchronized with the forming machine 3 by the output order written in its memory or possibly by its connection to signals from the forming machine, particularly the top machine.

The operation of the facility 1 according to the invention follows directly from the description above. Upon passage of the containers 2 in front of the sensor system 15₁ of the determination system 15, the containers 2 are detected and their transverse positions on the conveyor along the axis Y and their longitudinal positions along the axis X are measured. After passage of the container in front of the sensor system 15₁ and before its passage in front of the laser apparatus 9, the measurement of the position of the container on the conveyor is calculated by the determination system 15 and more particularly by the processing unit 15₂. The control unit 14 calculates the optical corrections to be possibly made to the laser beam in order to drive accordingly the system 11 for moving the plane of focus of the laser apparatus 9. The focal or working plane of the laser beam is therefore adapted to the position of the container before its passage in front of the laser apparatus 9. This focus plane is the location along the beam where the energy is maximum to make the melting or ablation of material on the container 2 during the marking. The displacement device 11 moves the plane of focus of the laser beam to thus optimize the marking made on the container. The control unit 14 drives the laser apparatus 9 to trigger the marking when the container passes in front of the laser apparatus.

It must therefore be understood that the method according to the invention includes a step of determining, before their marking, the position of the containers, along a direction Y transverse to the direction of translation D of the containers and a step of adapting the plane of focus of the laser beam F as a function of the position of the containers to be marked so that the laser beam can then ensure an operation of marking the containers passing in front of the laser beam F. The marking operation is therefore ensured by the laser beam F whose position of the focus plane, more specifically the range of distances along the direction At in which the beam is sufficiently concentrated to contain the maximum energy, has been previously optimized to ensure the marking of the containers. It should be noted that this method is implemented for each container running past the laser apparatus 9. Of course, the step of adapting the focus plane may be optional in the case that two consecutive containers occupy the same transverse position on the conveyor.

According to the invention, the system 15 for determining the longitudinal position and the transverse position of the marking area R of each container includes, as a sensor system 15₁, at least a first light sensor E1 having a first optical axis A1 and a second light sensor E2 having a second optical axis A2. A light sensor E1, E2 generally comprises, for example, a photoelectric sensor having a certain spectral sensitivity, converting the received light into an electrical signal, and a means for focusing the light on the photoelectric sensor. The focusing means of the lens or objective type is generally adapted to focus a narrow parallel beam, which determines in space a virtual barrier whose crossing by an object modifies the perceived light. The optical sensor therefore has an optical axis which corresponds to a straight line or a line segment in the space traversed by the running containers.

The optical axes A1 and A2 of the light sensors E1, E2 are positioned in a non-parallel manner to each other, in a detection plane Pd parallel to the conveying plane Pc and located at a height at least close to the height of the marking area R. It must be understood that the detection plane in which the transverse position of the marking area is determined must correspond as much as possible to the marking area or possibly to an area having, due to the shape of the container, the same transverse position as this marking area. Advantageously, the optical axes A1 and A2 of the light sensors are positioned so that the detection plane Pd is secant to the marking area R and preferably secant to the middle of the marking area R. In other words, the detection plane Pd advantageously contains the marking axis At. Such a disposition allows detecting with accuracy the actual position of the marking area R, such as that of the neck of a container that may or may not have a leaning neck (FIG. 3).

The light sensors E1, E2 are mounted in a fixed manner relative to the containers in translation. As can be seen from FIG. 4, the optical axes A1 and A2 are positioned such that each container 2 is caused to cross each optical axis during its translation. Thus, each light sensor E1, E2 is adapted to detect the instant when a container 2 intersects its optical axis and the instant when, following the translation of the container 2, this container interrupts the intersection of the optical axis that is to say releases the optical axis.

According to a first variant, at least one light sensor E1, E2 includes a light emitter and a light receiver, disposed on either side of the trajectory of translation of the containers.

According to a second variant, at least one light sensor E1, E2 includes a light emitter and a light receiver, disposed on the same side of the trajectory of translation of the containers. A light reflector is disposed along the opposite side to redirect, towards the receiver, the light coming from the light emitter.

According to these variants, each light sensor receives along its optical axis, in the absence of a container intersecting its optical axis, a light beam. The instants of intersection and disengagement are detected respectively by the disappearance and appearance of light received by the light receiver upon passage of a container.

According to a third variant, a light sensor E1, E2 is an infrared light sensor or an optical pyrometer. Such an optical pyrometer called location pyrometer is sensitive to the infrared radiation emitted by the hot containers, so as to receive along its optical axis the infrared light emitted by a container crossing its optical axis. The instants of intersection and disengagement are detected respectively by the appearance and disappearance of the infrared light received by the optical location pyrometer upon passage of a container.

The determination system 15 detects the instant of intersection or disengagement, by a container 2, of the first optical axis A1 and the instant of intersection or disengagement, by a container, of the second optical axis A2. Then, the determination system 15 calculates the transverse position and the longitudinal position of the marking area of the container 2 from these instants and in consideration of a known and/or constant speed of translation of the containers. The determination system 15 also determines the marking instant for each container running past the marking station, from the determination of the longitudinal position of the marking area.

The following description describes examples of calculations to determine the transverse position of the marking area of the container 2 from the instant of intersection or disengagement, by a container 2, of the first optical axis A1 and from the instant of intersection or disengagement, by a container 2, of the second optical axis A2. The calculations are presented to indicate the approach to those skilled in the art in a particular configuration of the optical axes A1 and A2 and in the frequent case that the containers are of circular section in the detection plane Pd.

FIG. 4 is a view of the detection plane Pd, plane parallel to the conveying plane Pc. This Figure is simplified to allow a geometric reasoning leading to the determination of the transverse position of the marking area of the container 2. The output conveyor 5 is represented by the trajectory of displacement in the direction D. The optical axes A1 and A2 of the light sensors E1, E2 are represented by straight lines. Considering for example the reference frame X, Y, the optical axes A1 and A2 intersect the longitudinal axis X at two points E1 and E2 respectively. The angles α₁ and α₂ are the unsigned angles of the optical axes A1 and respectively A2 with the transverse axis Y.

In FIG. 4, the orthonormal reference frame with a longitudinal axis X and a transverse axis Y is located with its origin at a point E1. The containers 2 move from left to right in the direction D parallel to the longitudinal axis X. The containers 2 are represented by a circle corresponding to the section of the casing of the container located in the detection plane Pd. Each center C of a container has coordinates XC and YC. The FIG. 4 simplified corresponds approximately to a device in which the points E1 and E2 can symbolize the optical centers of the light sensors with the intersection of the optical axes A1, A2 located on the output conveyor. In the example illustrated in FIG. 4, the optical axes A1 and A2 are concurrent at a point located along the longitudinal axis X between the points E1 and E2 and along the transverse axis Y on the left of the containers in translation. For example, the concurrent point of the optical axes A1 and A2 is located on the left edge of the output conveyor. This configuration corresponds to a positive angle α₁ in the clockwise direction and a positive angle α₂ in the counterclockwise direction. Those skilled in the art can easily adapt the calculation to other configurations of optical axes such as those illustrated in FIG. 7A, where the concurrent point of the optical axes A1 and A2 is located along the longitudinal axis X upstream of E1, and in FIG. 7B where the concurrent point of the optical axes A1 and A2 is located along the transverse axis Y, on the right of the containers in translation.

Since the displacement of the containers is theoretically parallel to the longitudinal axis X, the transverse position YC of the center of the container does not vary during the displacement, therefore remains constant during the crossing of the optical detection axes A1, A2 and of the marking axis At.

The longitudinal position XC of the center C of the container varies with the speed translation Vt so that this longitudinal position of the container relative to the marking axis At varies, therefore XC(t). The speed Vt being known, it suffices to know XC(t) at an instant t to predict its value at another instant, or conversely the time that elapses between one position and another. In the case that the speed Vt of the output conveyor is assumed to be constant, a duration Δt corresponds proportionally to the traveled displacement, therefore a length d=Vt×Δt.

Upstream of the marking station, that is to say before the containers cross the marking axis At, the center C of the containers successively passes into the configuration illustrated by six remarkable positions. The positions P1, P′1 and P″1 correspond to the positions of the center C of the container when the container intersects respectively the first optical axis A1, the center of the container intersects the first optical axis A1, and the container releases the first optical axis A1. Likewise, the positions P2, P′2 and P″2 correspond to the positions of the center C of the container when the container intersects respectively the second optical axis A2, the center C of the container intersects the second optical axis A2, and the container releases the second optical axis A2. Of course, another point of the container different from the center C could have been taken to characterize these characteristic positions.

FIG. 5 shows by way of example the level of the output signals S1, S2 of the light sensors E1, E2 which change state between the positions P1 and P″1 and P2 and P″2. Moreover, the instants TC1, TM1 and TL1 correspond to the instants when the container intersects respectively the first optical axis A1 (instant of intersection), the center of the container intersects the first optical axis A1, and the container releases the first optical axis A1 (instant of disengagement). Likewise, the instants TC2, TM2 and TL2 correspond to the instants when the container intersects respectively the second optical axis A2 (instant of intersection), the center of the container intersects the second optical axis A2, and the container releases the second optical axis A2 (instant of disengagement).

When the outer diameter Ø of the container is known, the transverse YC and longitudinal XC positions of the center of the container can be determined as follows, for example for the positions P′1 and P′2.

Let TM1 (resp. TM2) be the instant when the center C of the container crosses the optical axis A1 (resp. A2) at a point P′1 (resp. P′2).

$${TM}_{1} = {TC}_{1} + \frac{∅ / 2}{Vt \times cos ( {α}_{1} )} {TM}_{2} = T {C}_{2} + \frac{∅ / 2}{V t \times cos ( {α}_{2} )}$$

Note that Ø/2 is the radius of the circular section of a round container or of the neck of a shaped article.

Let dcc be the distance traveled between these two positions P′1 and P′2 where the center C of the container crosses the optical axes A1, A2.

dcc=(TM₂−TM₁)×Vt

In the configuration dcc is greater than 0.

$$Y C = ( \frac{( E 1 E 2 - dcc )}{t g ( {α}_{1} ) + t g ( {α}_{2} )} )$$

Where E1E2 is the distance between points E1 and E2 symbolizing the optical centers of the light sensors.

Knowing the diameter Ø of the container, the firing distance, therefore the transverse position YR of the marking area R is:

YR=YC−Ø/2

It is now possible to determine the longitudinal position XC(t) for example at the instant TM2, i.e. at the ordinate of the position P′2:X(P′2)=XC(TM2).

XC(TM2)=E1E2−YC.tg(α₂)

The firing or marking instant Tfiring is then the instant when the marking area R crosses the marking axis At of coordinates X(T). So that the marking is made in the center, the firing or marking instant Tfiring is the instant when the center of the container (XC(t), YC) crosses the marking axis At, that is to say when the ordinate XC of the center of the container corresponds to X(T):

Tfiring=(X(T)−XC(TM2))/V t

If the diameter Ø is unknown a priori, then this diameter can be estimated using the distances:

Ø=Vt x(TL1−TC1) or Ø=Vt x(TL2−TC2)

In other words, according to an advantageous variant, the instants of intersection TC1 and disengagement TL1 of the optical axis A1, or the instants of intersection TC2 and disengagement TL2 of the optical axis A2 are used for the calculations aiming at determining the diameter of the containers. The calculated diameter can for example specify the firing distance, and therefore the transverse position XR of the marking area R, for example for conical regions of the containers.

It is also possible to determine the instant TM1 (resp. TM2) where the center C of the container crosses the optical axis A1 at a point P1 (resp. A2) as follows, without actually calculating the diameter:

$${TM}_{1} = \frac{( TL 1 - TC 1 )}{2} {TM}_{2} = \frac{( TL 2 - TC 2 )}{2}$$

In the case of containers whose section through the detection plane is not circular but only symmetrical, the formulae above apply by considering the instant

TM1 (respectively TM2) as the instant when the center of symmetry XC(t), YC of the container crosses the optical axis A1 (resp. A2) at a point P′1 (resp. P′2). A symmetrically shaped container is a container such that the casing of its section through the detection plane has central symmetry. The shapes are for example rectangles, squares, ovals, ellipses. For example when the detection plane Pd is positioned at the body (to engrave on the body), the section is rectangular, square, elliptical, etc.

It is also possible to determine by the method according to the invention the orientation θ of the containers about the vertical axis Z. This orientation θ is considered to be zero if the marking area is parallel to the longitudinal axis X that is to say perpendicular to the transverse axis Y. This allows correcting even more accurately the firing distance YR and the firing instant in order to position the marking correctly, for example in the center of the large face 20 of a parallelepiped as illustrated in FIGS. 6A to 6C showing a container of rectangular section having a large planar face 20 on which the marking area R is made.

In FIG. 6B, it appears necessary for a container 2 with an orientation θ relative to the longitudinal axis X, to delay the marking instant Tfiring and to focus the marking laser beam recessed relative to a container passing with a zero orientation e.

According to one variant of the invention, the focus plane can also be moved during the marking, when the marking area R is large relative to the curvature of the surface of the marking area R. To do so, it is necessary that the control unit knows the shape of the marking area R and also calculates the orientation θ of each container.

Another effect of the orientation θ of each container is that when the face is not normal to the laser beam, the geometry of the marking is modified. For example, a projected square will produce a trapezoidal-shaped marking as illustrated in FIG. 8k In other words, the marking undergoes a “trapezoidal deformation”. In the case of a DATAMATRIX code intended for automatic reading, the deformation presents a risk of incorrect reading, even if the reader is able to read slightly deformed codes, Thus, for a container having a non-zero orientation θ, it is recommended to correct the geometry of the marking.

According to one advantageous variant of the invention, the control unit 14 determines, thanks to the sensors of the location system 15, the orientation θ of each container and drives the scanning device 10 to correct the geometry of the marking by canceling the trapezoidal deformation that is to say to obtain a marking with a geometry compliant with the desired one.

According to one advantageous example of the invention, the orientation θ of each container being known, the angle of incidence of the laser beam on the marking area assumed here on the surface of a planar face of the container is known. By definition here, the angle of incidence is the angle of the laser beam with the normal to the reached surface. As illustrated in FIG. 6C, the angle of incidence of the beam F on the face 20 of the container 2 is also equal to θ. Due to this angle of incidence, the geometry of the marking may be deformed by the non-orthogonal projection on the receiving face. This deformation of the geometry of the marking may result, in the case of a bar or DATAMATRIX code, in difficulties of re-reading by dedicated optical readers.

This drawback is overcome according to the invention by considering the orientation θ of each container to drive the scanning system 10 in order to produce a marking maintaining the desired geometry on each container. Thus, according to one variant of the invention, the orientation θ of each container relative to the direction of displacement D is determined and the laser beam F scanning system is driven in order to produce a marking of constant geometry on the marking area regardless of its orientation relative to the direction of displacement D.

When the marking consists for example of a set of hollows each corresponding to an impact of the laser beam, each hollow constituting a dot of a dot code, for example of the DATAMATRIX type, the correct three-dimensional geometry of each hollow (position, circularity and depth of the relief) has the effect that the hollow will be easily detected by an automatic code reader. In the case that that the angle of incidence of the laser beam F on the marking area is high, the dots of a dot code may have their geometry altered. In other words, if the angle of incidence of the laser beam F exceeds a threshold, the marking quality is deteriorated.

According to one variant, it is provided to determine the orientation θ about the vertical axis Z of each container, on which the incident angle of the laser beam depends, and in the case that the orientation angle θ exceeds an angle threshold value corresponding to a marking quality value, one of the following operations is performed:
the containers oriented incorrectly are not marked;
an alert information is triggered, possibly by indicating the original sections of the containers oriented incorrectly;
the mechanisms for placing the containers in line are corrected.

According to a preferred exemplary embodiment, one of the two optical axes A1 or A2 is orthogonal to the translation direction. In the case that the first optical axis A1 is orthogonal to the translation direction, the longitudinal position XC is derived:
from the instant TC1 at which the free optical axis A1 is intersected or the instant TL1 at which the optical axis A1 is disengaged by the hot container;
from the speed of the conveyor;
from the longitudinal length or the longitudinal diameter in the direction of translation of the section of the container taken at the detection plane.

Of course, the calculations described above are given by way of non-limiting examples. The transverse position of the containers and the longitudinal position of the containers can be determined in a different way. In general, the facility 1 includes a device for providing the processing unit 15₂ with different information to carry out these calculations. Such a device, such as a man/machine interface or an internal memory, has information taken from the following list:
the longitudinal position of the light sensors E1, E2;
the transverse distance between the different elements of the light sensors E1, E2;
the angle of the optical axes A1, A2 of the light sensors with the direction transverse to the translation Y;
dimensions such as the diameter Ø for a cylindrical container or the width and length W×I for shaped containers;
the speed of the conveyor Vt;
the height of the marking region R relative to the plane of the conveyor;
the longitudinal position of the marking axis At.

This man/machine interface and/or likewise, this internal memory of the control unit 14, may be the same as the one necessary to provide the other marking parameters such as the laser power, the scanning speeds, the type of marking, code, the content of the information to be marked, and therefore all the parameters necessary for the laser marking.

To make a marking by the laser beam, a scanning device generally deflects the beam horizontally and vertically. When the containers to be marked are fixed during the marking, then the horizontal and vertical scanning displacements are determined only by the dimensions and geometries of the pattern and the generally constant distance from the marking area. The distance indeed intervenes since the deflection of the beam is an angular deflection per deflector (galvanometric mirror) then the distance of the marking area relative to the laser beam is taken into account to determine the scanning movements. In other words, if the marking area is further away, then the angles of deflection of the laser beam by the scanning device are reduced vertically and horizontally. Simple trigonometry calculations are sufficient and can be easily determined by those skilled in the art.

For the marking of movable containers, it is known that the laser beam must at the same time travel through the marking area as for a fixed container, but also follow the longitudinal displacement of the containers. The vertical and horizontal scans are compensated to take into account the displacement of the containers. It suffices to know the speed of displacement, which can moreover be generally constant, alternatively it is measured, these two alternatives being possible in the method according to the present invention. Taking into account the displacement of the containers also depends on the distance from the marking area, which is generally constant.

For the marking of hot containers running on an output conveyor with imperfect alignment, the transverse position YR of the marking area, therefore the distance between the laser output window and the marking area varies. This may result in a variation, from one container to the other, in the vertical and horizontal dimensions of the marking or of the marking area R.

According to one advantageous variant of the invention, taking into account the displacement of the containers consists in taking into account the known longitudinal displacement speed, whether it is constant or not, or it can be measured, and the distance from the marking area.

In the case of the invention, where the containers move in the longitudinal direction which is almost horizontal, the compensation of the vertical displacement of the beam as a function of the distance is recommended but is not absolutely necessary, because the vertical effect is low. Conversely, the effect of the distance on the horizontal dimension of the marking area is strong due to the displacement.

In other words, according to one advantageous variant of the invention, the transverse position YR of the marking area R of each container is measured, then the control unit drives the laser beam scanning device in order to adapt at least the horizontal displacements of the laser beam as a function of the speed of displacement and of the transverse position YR of the marking area R of each container in order to maintain at least the width of the marking area constant.

The laser apparatus 9 is height-adjustable. More specifically, according to the invention, the laser beam output window is height-adjustable relative to the conveying plane Pc. According to one variant, the position of the scanning device 10 is independent of that of the laser apparatus which is fixed. Indeed, the system marketed under the name “Multiscan” from the company ROFIN has a means for leading the laser beam from the source up to the scanning device, within an articulated arm. In another configuration, a larger part of the laser apparatus moves in height, for example the source, the scanning device and the device for moving the focal plane. These adjustments are usually provided to be manual but can be motorized. Thus, the adjustment means can be constituted by any means, such as jacks, levers or endless screws actuated by cranks. If they are motorized, the cranks are for example replaced by electric motors.

According to one variant of the height drift compensation, the control unit 14 drives height adjustment means as a function of the height drifts. These adjustment means move the complete laser apparatus or at least the scanning device carrying the laser output window.

According to another characteristic of the invention, the method according to the invention measures the height of the marking axis At relative to the conveying plane Pc and drives the laser apparatus 9 so that the marking axis At is positioned at a desired height relative to the conveying plane Pc. The height of the marking region R is always suitably positioned relative to the bottom of the containers, therefore to the container laying plane, regardless of the height variations of the conveyor. Different solutions can be implemented to maintain the marking area or the marking axis at a fixed height relative to the conveying plane Pc.

According to one variant of the height compensation, the control unit drives the height adjustment means as a function of the measurement of the height of the conveying plane. These adjustment means move the complete laser apparatus or at least the scanning device carrying the laser output window. These adjustment means may be those that allow the adjustment upon the manufacturing change in order to position the marking area R as a function of the production and in particular the models of containers manufactured and of the height of the output conveyor of the forming machine. In this case, the adjustment amplitude is of at least 400 millimeters. In another variant, the height drift compensation means aiming at correcting the height drifts have adjustment amplitude of less than 30 mm and are different from the height adjustment means during the manufacturing change which have amplitude of at least 400 mm. Unlike the height adjustment means during the manufacturing change which are either manual or motorized, the height compensation means aiming at correcting the height drifts are necessarily motorized and driven by the control unit 14. The facility therefore includes a conveyor height sensor. This sensor regularly measures the height of the conveying plane Pc of the conveyor relative to a reference linked to the laser beam, to the ground or to the position sought for the conveying plane. The height sensor can be of any type. A distance sensor can be installed. It is possible to use an optical distance sensor, for example with triangulation. But a mechanical sensor is also usable, for example a taut wire sensor.

To compensate for the height drifts, the control unit 14 can also control the scanning device 10 so as to move the marking area. It is then the laser beam scanning device that therefore moves the marking area. In other words, the scanning device 10 tilts up or down the average direction of the laser beam as a function of the height drifts detected by the conveyor height sensors.

When the height of the conveyor varies, the detection plane Pd should preferably remain adjacent or aligned on the marking region. For example, the detection plane is at a constant height relative to the conveyor. In the case that the height compensation is obtained by displacement of the scanning device or of the complete laser apparatus, then the detection plane Pd can be secured to the scanning device or to the laser apparatus. For a simple device, it is therefore provided that the optical sensors E1, E2 are held by a support secured to the laser apparatus, with the detection plane positioned to coincide with the laser output window regardless of the height-adjustment of the laser apparatus.

Conversely, when the height drift compensation is operated by deflection of the marking beam (displacement of the marking area by the driving of the scanning device) then it is provided that the detection plane remains secured to the conveyor. In this case, it will be provided a height-adjustment of the detection plane relative to the conveyor during the manufacturing change, therefore during the adjustment of the nominal position of the marking area.

For a simple device, it is therefore provided that the optical sensors E1, E2 are held by a support secured to the conveyor, said support being height-adjustable relative to the conveyor for the adjustment phases. A visual reference frame can be provided to place the detection plane at the marking area or at the laser firing window.

The forming machine can be set to manufacture several different models of containers at the same time. In this situation, some sections of the forming machine do not produce the same models of containers as other sections. A succession of different containers can then run through the marking facility, each with a marking area placed at a different height. The control unit knows by the synchronization method the original section of each container at the moment of its passage in front of the laser apparatus. Depending on the original section of each container, the control unit 14 drives the laser beam F scanning device so as to position the marking area R at the height adapted to each container model 2. For example, if the production includes articles 300 mm high and articles 350 mm high, with the need to place a DATAMATRIX code 30 mm below the top (or the surface of the ring) for both types, then the marking area must be positioned either 270 mm or 320 mm above the conveying plane Pc as a function of the original section of the containers. Of course, the displacement of the marking area has an amplitude limited by the capacities of the scanning device.

According to one variant of the invention therefore, the control unit drives the laser beam scanning device to adapt the height of the marking area as a function of the original section of each container when the succession of containers to be marked includes containers of different models.

According to one advantageous characteristic of embodiment, the method according to the invention measures the inclination of the conveying plane Pd. This measurement of the inclination is taken into account by the knowledge of the inclination of the output conveyor or by a measurement by an inclination sensor. The laser beam is driven by taking into account the inclination of the conveying plane so that the marking maintains its geometry as a function of the detected inclination.

Indeed, the conveyor can have a variable slope, therefore an inclination relative to the ground. If the conveyor is not horizontal, then the axis of the containers is not vertical and the direction of displacement D is not horizontal. The possible consequence is a deformation of the marking such that a theoretically square marking takes the shape of a diamond as illustrated in FIG. 8B. There appears the need that the scanning device, which is driven to deflect the laser beam F by following the displacement D of the articles during the marking operation, performs the deflections of the laser beam F according to the inclination of the containers and especially their direction of displacement, therefore according to the angle of inclination of the conveyor. It can be provided to position the scanning device by providing it with an additional axis of freedom, therefore a rotation about the firing or transverse axis Y. according to one variant, the entire laser apparatus is inclined by the same angle. This adjustment is manual or motorized.

A preferred solution consists in taking into account the inclination relative to the apparatus for marking the conveying plane Pc in order to drive the laser scanning device, so as to maintain the geometry of the marking, and therefore to avoid diamond deformation of the marking. This less expensive and reliable solution allows automatic adjustment without mechanical displacement of the members of the laser apparatus.

The inclination angle can be entered on the MMI of the control unit 14. To make this adjustment automatic as a function of the inclination of the conveyor, it is necessary to measure the inclination of the conveyor.

One solution consists in using two conveyor height sensors, distant from each other. By trigonometry, the two heights deliver to the control unit 14, the inclination of the conveyor.

One alternative is to use an inclinometer, secured to the conveyor. There are, for example, MEMS-based inclinometers, which give the inclination of an object along an axis, by using the action of gravity on a weight or a liquid.

According to the invention, the facility can therefore be equipped with a means for measuring the inclination of the conveyor, the control unit being connected to this means and configured, as a function of the angle of inclination of the conveyor, to drive the scanning device so as to maintain the geometry of the marking.

It can be preferably provided to incline the detection plane Pd to keep it parallel to the conveying plane Pd, regardless of the means for adjusting the height, or to correct the height drifts, whether the sensors E1 and E2 are secured to the conveyor or to the laser apparatus 9.

According to one characteristic of embodiment, the first optical axis of the first light sensor and the second optical axis of the second light sensor form therebetween an angle comprised between 5° and 60°. This angle is represented by the angel 13 in FIG. 9. This characteristic allows taking into account the spacing and the offset between the containers. An optical axis A1 with a greater angle compared to the transverse axis Y would not be released between the passage of two consecutive containers. In other words, the angle between an optical axis for the detection and the transverse direction Y must not exceed the angle between the transverse direction Y and a straight line tangent to two successive containers having therebetween the maximum transverse offset.

The support of the optical sensors E1, E2 can be equipped with adjustments of the angles of the axes A1 and A2 relative to the transverse direction, namely the angles α₁ and α₂ each comprised between 45° in the clockwise direction and 45° in the counterclockwise direction. This adjustment will be aimed to create between the two optical axes an angle between 5° and 60°. For example α₁ is equal to 0°, and α_{z} is equal to 20°.

According to one characteristic of the invention, an optical monitoring pyrometer 18 is disposed to provide, from the infrared radiation emitted by the hot containers, a measurement of the temperature of the marking area R at the moment when said area intersects its optical axis, in order to determine whether said temperature is above a temperature threshold such that the engraving will be of good quality. This optical monitoring pyrometer 18 is disposed upstream of the laser apparatus 9 to provide a measurement of the temperature of the marking area R just before the marking operation by the laser apparatus.

According to one preferred variant of the invention, the optical monitoring pyrometer 18 measures the surface temperature of the container. It is therefore not very sensitive to the radiation passing through the glass. For example, the optical monitoring pyrometer 18 is sensitive to wavelengths greater than 3 microns, preferably greater than 5 microns, for example between 5 and 8 microns.

The method according to the invention provides for marking a code containing information on the original cavity of each container. The control unit therefore knows by the synchronization method, the cavity and/or the original section of each container at the moment of its passage in front of the laser apparatus, and obviously, at the moment of the measurement of temperature of the marking area R. The control unit can therefore associate the temperature of the marking area and the faults of this temperature with the cavities or sections which pose a problem. A priori, the containers with a cold area are those coming from the sections furthest from the marking station, but other causes than the cooling during conveying may explain that other sections have this fault.

One means of action consists in heating the marking areas with a flame upstream of the marking station. But the drawback of creating too hot marking areas may appear. It is therefore advantageous to act only on the containers coming from certain cavities or certain sections.

In the case that the measurement of temperature of the marking region R is below a determined threshold typically equal to 450° C., at least one of the following actions is carried out:
positioning of an alarm signal, possibly resumed by a visual or audible alert or the like, intended for the operators of the line;
the non-marking of the container whose temperature measurement is insufficient;
the operating of a device for heating the marking area, such as for example a gas burner flame directed on the marking area, located upstream of the laser apparatus, permanent or intermittent as a function of the original sections and/or cavities of the containers;
a modification of the container forming method, aiming at raising the temperature of the marking area for at least the sections and/or cavities affected by the temperature fault.

As a result from the foregoing, according to the method, the control unit 14 drives the laser beam scanning device as a function of the transverse position YR of the marking area determined for each container, possibly (for the shaped containers) of the orientation θ about the vertical axis Z of each container, of the inclination of the conveyor, of the height of the conveyor measured regularly, to obtain a marking correctly placed on the article in height along Z relative to the conveying plane, in centering along X or relative to a face of the article, and in inclination relative to the conveying plane, and of conform horizontal dimension along X.

According to the method, the control unit drives the laser beam scanning device as a function of the transverse position YR (or also vertical position XR) of the marking area determined for each container so that the mark has a constant vertical dimension.

According to the method, the orientation of the containers and the temperature of the marking region are monitored in order to ensure good marking quality, and to allow intervention or correction of the method in the case of a drift.

The method therefore allows ensuring the stability of the geometry and of the rendering of the marking on the hot containers at the outlet of the forming machine.

It emerges from the description above that the object of the invention allows marking containers at the outlet of a forming machine:
with a marking area whose position is detected in a simple and inexpensive way, using at least two light sensors with non-parallel optical axes and/or,
with a marking of good quality because the marking operation is carried out only if the container has the appropriate temperature and/or,
with a marking area positioned on the container at the desired location regardless of the variations in the height of the conveying plane and/or,
with a marking according to a given inclination relative to the container laying plane and/or,
with a marking whose width is controlled whatever the speed of displacement and the transverse position of the containers and/or,
with a marking area whose orientation relative to the direction of displacement is determined to maintain a marking quality.

The invention is not limited to the described and represented examples because various modifications can be made without departing from its scope.

1- A method for marking, at the outlet of a forming machine (3) using a laser beam, a marking area (R) on hot glass containers (2) laid on a conveying plane (Pc) of a conveyor (5) and running in translation successively past a laser apparatus (9), the method including the following steps:
determining for each container before its marking, the longitudinal position (XR) along the translation direction and the transverse position (YR) along a transverse direction (Y) relative to the direction of translation (D) of the marking area (R);
moving, along the transverse direction (Y), the plane of focus of the laser beam as a function of the transverse position of the marking area of each container to optimize the subsequent operation of marking the containers running past the laser beam;
and making on the marking area of each container, a marking along a marking axis (At) by the laser beam whose position of the focus plane has been optimized to ensure the marking,
characterized in that, in order to determine the longitudinal position and the transverse position of the marking area of each container it consists in:
positioning a first optical axis (A1) of a first light sensor (E1) and a second optical axis (A2) of a second light sensor (E2) in a non-parallel manner to each other, in a detection plane (Pd) parallel to the conveying plane (Pc) and located at a height at least close to the height of the marking area, the first optical axis (A1) and the second optical axis (A2) being located so that each container is caused to cross each optical axis during its translation before the marking, the direction of the optical axes (A1) and (A2) relative to the direction of displacement and their position relative to the marking axis (At) being known;
detecting the instant of intersection (TC1) or disengagement (TL1), by a container, of the first optical axis (A1) and the instant of intersection (TC2) or disengagement (TL2), by a container, of the second optical axis (A2);
and calculating said transverse and longitudinal positions from these instants and in consideration of a known or constant speed of translation (Vt) of the containers;
the method consisting in determining, from the determination of the longitudinal position of the marking area, the marking instant for each container running past the laser apparatus (9).

2- The method according to claim 1, characterized in that it consists in:
detecting the instant of intersection (TC1) of the first optical axis (A1) by a hot container, and
detecting the instant of disengagement (TL1) of the first optical axis (A1) by a hot container, and
detecting the instant of intersection (TC2) of the first optical axis (A2) by a hot container, and
detecting the instant of disengagement (TL2) of the first optical axis (A2) by a hot container,
to derive therefrom the transverse and longitudinal position (XC, YC) of the center of central symmetry (C) of the section by the detection plane, of the casing of each container, and to derive the longitudinal position (XR) of the marking area (R) from at least the longitudinal position (XC) of the center of symmetry (C), and to derive the transverse position (YR) of the marking area (R) from at least the position transverse (YC) of the center of symmetry (C).

3- The method according to claim 2, wherein from the four instants of intersection (TC1, TC2) and disengagement (TL1, TL2) of the first sensor and second sensor, the orientation (θ) of the section of the container is determined by the detection plane (Pd) of the casing of each container, and as a function of said orientation (θ):
the transverse position (YR) and the longitudinal position (XR) of the marking region (R) are determined;
and/or the scanning device is driven to obtain a marking with a geometry compliant with the desired one;
and/or alert information is delivered when the orientation (θ) exceeds a marking quality value.

4- The method according to claim 1, according to which the optical axes (A1, A2) of the light sensors (E1, E2) are positioned so that the detection plane (Pd) is secant to the marking area (R) and preferably in the middle of the marking area.

5- The method according to claim 1, wherein the first optical axis (A1) of the first light sensor (E1) and the second optical axis (A2) of the second light sensor (E2) form therebetween an angle (3) comprised between 5° and 60°.

6- The method according to claim 1, wherein at least one light sensor (E1, E2) receives along its optical axis, in the absence of a container (2) intersecting its optical axis, a light beam coming from an emitter of the light sensor, the instants of intersection (TC1, TC2) and disengagement (TL1, TL2) being detected respectively by the disappearance and appearance of light received by a light receiver of the light sensor upon passage of a container.

7- The method according to claim 1, according to which at least one light sensor (E1, E2) is an optical location pyrometer sensitive to the infrared radiation emitted by the hot containers (2), so as to receive along its optical axis (A1, A2) the infrared light emitted by a container crossing its optical axis, the instants of intersection and disengagement being detected respectively by the appearance and disappearance of the infrared light received by the optical pyrometer upon passage of a container.

8- The method according to claim 1, according to which the measurement of the transverse position (YR) of the marking area (R) is taken into account in order to control the laser apparatus by adapting at least the horizontal displacements of the laser beam as a function of the speed of displacement and of the transverse position (YR) of the marking area (R) of each container in order to maintain constant at least the width of the marking area.

9- The method according to claim 1 wherein an optical monitoring pyrometer (18) is disposed to provide, from the infrared radiation emitted by the hot containers (2), a measurement of the temperature of the marking area (R) at the moment when said area intersects its optical axis, in order to determine whether said temperature is above a temperature threshold such that the engraving is of good quality.

10- The method according to claim 9, wherein in the case that the measurement of temperature of the marking region (R) is below a determined threshold, at least one of the following actions is carried out:
positioning of an alarm signal, possibly resumed by a visual or audible alert or the like, intended for the operators of the line;
the non-marking of the container whose temperature measurement is insufficient;
the operating of a device for heating the marking area, located upstream of the laser apparatus;
a modification of the container forming method, aiming at raising the temperature of the marking area.

11- The method according to claim 1, according to which the height of the conveying plane (Pc) is measured at least regularly, and in that the control unit drives, as a function of the measurement of the height of the conveying plane, means for height-adjusting the position of the laser apparatus in order to maintain the marking area (R) or the marking axis (At) at a fixed height relative to the conveying plane (Pc).

12- The method according to claim 1, according to which the height of the conveying plane (Pc) is measured at least regularly, and in that the control unit drives, as a function of the measurement of the height of the conveying plane, the laser beam scanning system to maintain the marking area (R) at a fixed height relative to the conveying plane (Pc).

13- The method according to claim 1, according to which the inclination of the conveying plane (5) is taken into account and the laser beam scanning system is driven in order to maintain the geometry of the marking.

14- A facility for marking, at the outlet of a forming machine (3), hot glass containers (2) laid on a conveying plane (Pc) of a conveyor (5) and running successively, at a constant or known speed of translation, past a laser apparatus (9), the facility including:
a system for determining before their marking, the longitudinal position (XR) of the marking region (R) along the direction of translation (D) of the containers and the transverse position (YR) of the marking region (R) in a direction transverse to the direction (D) of running of the containers;
a laser apparatus (9) including a laser beam generator along a marking axis (At);
and a control unit (14) configured to drive a device (11) for moving, along the transverse direction (Y), the plane of focus of the laser beam as a function of the transverse position (YR) of the marking region (R) in order to optimize the operation of marking the containers running past the laser beam, characterized in that the system (15) for determining the longitudinal position and the transverse position of the marking area of each container (2) includes:
a first light sensor (E1) having a first optical axis (A1) and a second light sensor (E2) having a second optical axis (A2), these optical axes (A1, A2) being positioned in a non-parallel manner to each other, in a detection plane (Pd) parallel to the conveying plane (Pc) and located at a height at least close to the height of the marking area (R), the first optical axis (A1) and the second optical axis (A2) being located so that each container is caused to cross each optical axis during its translation, the direction of the optical axes (A1) and (A2) relative to the direction of displacement and their position relative to the marking axis (At) being known;
and a processing unit (15₂) detecting the instant of intersection (TC1) or disengagement (TL1) by a container, of the first optical axis (A1) and the instant of intersection (TC2) or disengagement (TL2), by a container, of the second optical axis (A2), and calculating said transverse and longitudinal positions from these instants and in consideration of a known or constant speed of translation of the containers, this processing unit determining the marking instant for each container running past the marking station, from the determination of the longitudinal position of the marking area.

15- The facility according to claim 14, wherein at least one light sensor (E1, E2) includes a light emitter and a light receiver, disposed on either side of the trajectory of translation (D) of the containers.

16- Facility according to claim 14, wherein at least one light sensor (E1, E2) includes a light emitter and a light receiver, disposed on the same side of the trajectory of translation (D) of the containers, a light reflector being disposed along the opposite side to redirect, towards the receiver, the light coming from the light emitter.

17- The facility according to claim 14, characterized in that a light sensor (E1, E2) is an infrared light sensor or an optical pyrometer.

18- The facility according to claim 14, characterized in that it includes an optical monitoring pyrometer (18) disposed upstream of the laser apparatus (9) to provide a measurement of the temperature of the marking area (R) at the moment when said area intersects its optical axis.

19- The facility according to claim 18 characterized in that the optical monitoring pyrometer (18) includes a spectral sensitivity for measuring the temperature of the surface of the glass containers.

20- The facility according to claim 14, characterized in that a device provides the processing unit with the information taken from the following list:
the longitudinal position of the light sensors (E1, E2);
the transverse distance between the different elements of the light sensors (E1, E2);
the angle of the optical axes (A1, A2) of the light sensors with the direction transverse to the translation;
dimensions (Ø or L×W) of the containers;
the speed of the conveyor (Vt);
the height of the marking region (R) relative to the plane of the conveyor;
the longitudinal position of the marking axis (At).

21- The facility according to claim 14, characterized in that it includes a sensor of the inclination of the conveying plane (Pc), connected to the control unit (14) configured to drive the laser beam so that the geometry of the marking is maintained regardless of the detected inclination.
